(19) United States
(12) Patent Application Publication
(10) Pub. No.: US 2016/0327244 A1
(43) Pub. Date: Nov. 10, 2016

(54) LIGHT-EMITTING DEVICE

(71) Applicant: SHARP KABUSHIKI KAISHA, Osaka-shi (JP)

(72) Inventors: Kazunori ANNEN, Osaka-shi (JP); Hiroshi FUKUNAGA, Osaka-shi (JP); Kenichi YOSHIMURA, Osaka-shi (JP); Tatsuya RYOHWA, Osaka-shi (JP); Masamichi HARADA, Osaka-shi (JP)

(73) Assignee: Sharp Kabushiki Kaisha, Osaka-shi (JP)

(21) Appl. No.: 15/108,117

(22) PCT Filed: Oct. 22, 2014
(86) PCT No.: PCT/JP2014/078027

§ 371 Date: Jun. 24, 2016

(30) Foreign Application Priority Data
Dec. 25, 2013 (JP) 2013-267553

(51) Int. Cl. F21V 9/16; F21K 9/64; F21K 9/61; F21V 8/00; F21V 7/06

(52) U.S. Cl. CPC F21V 9/16; G02B 6/0008; F21V 7/06; F21K 9/61; F21K 9/64; F21Y 2115/30

(57) ABSTRACT

The occurrence of a color irregularity in light that is emitted from a light-emitting device is suppressed together with being able to prevent a decline in the utilization efficiency of excitation light. A light-emitting device is provided with a phosphor section that absorbs excitation light and emits first fluorescence, and a phosphor section that absorbs excitation light that has passed through the phosphor section without being converted into first fluorescence by the phosphor section and emits second fluorescence. Also, the peak wavelength of the second fluorescence is approximate to the peak wavelength of the excitation light.

### CROSS-REFERENCE TO RELATED APPLICATIONS

This application is a U.S. National Phase patent application of International Patent Application No. PCT/JP2014/078027, filed Oct. 22, 2014, which claims priority to Japanese Application No. 2013-267553, filed Dec. 25, 2013, each of which is hereby incorporated by reference in the present disclosure in its entirety.

### FIELD OF THE INVENTION

The present invention relates to a light-emitting device and the like that use light emitted by a phosphor.

### BACKGROUND ART

The development of light-emitting devices, light guide devices, and the like that have a configuration in which a laser element or the like is used for an excitation light source, a phosphor is excited by excitation light emitted from the excitation light source, and fluorescence is emitted from the phosphor has been advancing. Light-emitting devices of this kind are disclosed in PTL 1 to 3, for example.

In PTL 1, a light-emitting device is disclosed having a light-emitting element and a light-transmitting body containing a wavelength conversion substance that absorbs light from the light-emitting element and performs wavelength conversion, or a light diffusion substance that reflects light from the light-emitting element.

In PTL 2, a light-emitting device is disclosed provided with: a plurality of separately formed light-emitting elements that are each capable of emitting light, which has strong directivity, in a predetermined direction; and a light-transmitting body containing a wavelength conversion substance that absorbs light from these light-emitting elements and performs wavelength conversion.

In PTL 3, a light-emitting device is disclosed having a light-emitting element that emits excitation light, a fluorescent substance that absorbs the excitation light and performs wavelength conversion to emit illumination, and an optical fiber that leads the light emitted from the light-emitting element to the fluorescent substance.

### CITATION LIST

PTL 1: Japanese Unexamined Patent Application Publication No. 2008-153617 (published on Jul. 3, 2008)

PTL 2: Japanese Unexamined Patent Application Publication No. 2008-282984 (published on Nov. 20, 2008)

PTL 3: Japanese Unexamined Patent Application Publication No. 2005-205195 (published on Aug. 4, 2005)

### SUMMARY OF THE INVENTION

In the light-emitting devices described in the abovementioned PTL 1 to 3, excitation light is converted into fluorescence when a light-transmitting body or fluorescent substance is irradiated with light (excitation light) emitted from a light-emitting device; however, not all of the excitation light is converted in the light-transmitting body or fluorescent substance. Furthermore, the excitation light that has not been converted into fluorescence is scattered by a wavelength conversion substance included in the light-transmitting body or the fluorescent substance; however, in this case also, not all of the excitation light is scattered.

In this way, when the excitation light is not completely converted into fluorescence or scattered, that excitation light that has not been completely converted or scattered passes through the light-transmitting body or the fluorescent substance and is emitted in a state having strong directivity from a location that opposes the location irradiated with the excitation light from the light-emitting element, in the light-transmitting body or the fluorescent substance. Meanwhile, the directivity of the fluorescence emitted from the light-transmitting body or the fluorescent substance is weak compared with the directivity of the excitation light that has not been completely converted or scattered. That is, outgoing light from the light-emitting device is in a state in which excitation light having strong directivity and fluorescence having weak directivity are mixed, in other words, a state in which the light distribution characteristics of the excitation light and the light distribution characteristics of the fluorescence are different, and therefore there has been a problem in that a color irregularity occurs.

Furthermore, in the technology of PTL 1 or 2, in the case where a light diffusion substance is included in the light-transmitting body, excitation light that is incident upon the light-transmitting body can be efficiently scattered, and it is therefore possible to suppress the occurrence of a color irregularity. However, part of that excitation light is scattered by the light diffusion substance and returns to the incoming side (in other words, the light-emitting element side), and therefore cannot be used as part of the outgoing light. In other words, in the technology of PTL 1 or 2, there has been a problem in that there is a decline in the utilization efficiency of excitation light.

Thus, in the technology of PTL 1 to 3, there has been a problem in that it has not been possible to suppress both the occurrence of a color irregularity and a decline in the utilization efficiency of excitation light.

The present invention takes the abovementioned conventional problems into consideration, and the objective thereof is to provide a light-emitting device that is able to prevent a decline in the utilization efficiency of excitation light, and is able to suppress the occurrence of a color irregularity in outgoing light emitted from the light-emitting device.

In order to solve the abovementioned problem, a light-emitting device according to an aspect of the present invention is a light-emitting device that emits fluorescence generated by subjecting excitation light to wavelength conversion and also part of the excitation light to outside, provided with:

a first light-emitting unit that absorbs the excitation light and emits first fluorescence; and

a second light-emitting unit that absorbs the excitation light that has passed through the first light-emitting unit without being converted into the first fluorescence by the first light-emitting unit and emits second fluorescence,

the peak wavelength of the second fluorescence being approximate to the peak wavelength of the excitation light.

According to an aspect of the present invention, an effect is demonstrated in that a decline in the utilization efficiency of excitation light is able to be prevented, and the occurrence of a color irregularity in outgoing light emitted from the light-emitting device is able to be suppressed.

### BRIEF DESCRIPTION OF THE DRAWINGS

FIG. 1 is a cross-sectional view depicting the schematic configuration of a light-emitting device according to embodiment 1 of the present invention.

FIG. 2 is a graph depicting light distribution characteristics of excitation light and fluorescence emitted from a light-emitting device serving as a comparative example of the light-emitting device according to embodiment 1 of the present invention.

FIG. 3 is a schematic cross-sectional view depicting the relative positional relationship of two phosphor sections in the light-emitting device according to embodiment 1 of the present invention.

FIG. 4 is a schematic diagram depicting the difference between outgoing light from the light-emitting device according to embodiment 1 of the present invention and outgoing light from the light-emitting device serving as the comparative example, (a) depicts the way in which outgoing light is emitted from the light-emitting device serving as the comparative example, and (b) depicts the way in which outgoing light is emitted from the light-emitting device according to embodiment 1 of the present invention.

FIG. 5 is a drawing depicting an example of experiment results indicating the relationship between the light emission intensity and wavelengths of outgoing light emitted from each of the light-emitting device according to embodiment 1 of the present invention and the light-emitting device serving as the comparative example.

FIG. 6 is a cross-sectional view depicting the schematic configuration of a light-emitting device according to embodiment 2 of the present invention.

FIG. 7 is a cross-sectional view depicting the schematic configuration of a light-emitting device according to embodiment 3 of the present invention.

FIG. 8 is a cross-sectional view depicting the schematic configuration of a light-emitting device according to embodiment 4 of the present invention.

FIG. 9 is a cross-sectional view depicting the schematic configuration of a light-emitting device according to a modified example of the present invention.

### DETAILED DESCRIPTION OF THE INVENTION

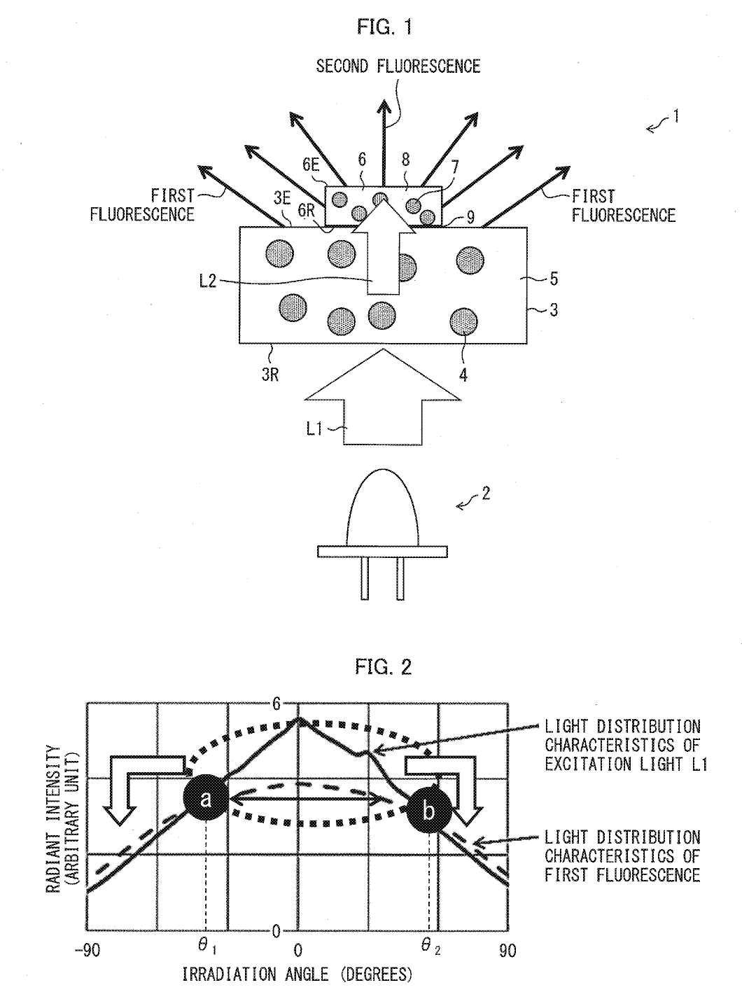

An embodiment according to the present invention is as follows when described on the basis of FIG. 1 to FIG. 5.

<Configuration of Light-Emitting Device 1>

FIG. 1 is a cross-sectional view depicting the schematic configuration of a light-emitting device 1 according to an embodiment of the present invention. The light-emitting device 1 emits fluorescence generated by subjecting excitation light to wavelength conversion and also part of the excitation light to outside, and, as depicted in FIG. 1, is provided with a laser element 2 (excitation light source), a phosphor section 3 (first light-emitting unit), a phosphor section 6 (second light-emitting unit), and an adhesive layer 9.

It should be noted that the basic structure of the light-emitting device 1 may be configured from a light-emitting unit that includes the phosphor section 3 and the phosphor section 6 that receive excitation light and emit light, and the light-emitting device 1 does not have to be provided with the laser element 2 if it is possible for the excitation light to be radiated onto the phosphor section 3.

The laser element 2 is a light-emitting element that functions as an excitation light source that emits excitation light L1 (laser light), in other words, a semiconductor laser (LD; laser diode). The laser element 2 may have one light emission point in one chip, or may have a plurality of light emission points in one chip.

The light emission wavelength of the laser element 2 may be a wavelength of the blue region of 420 nm or more and 490 nm or less. In the present embodiment, the laser element 2 emits the excitation light L1, which has a peak wavelength in the proximity of 450 nm, for example. For example, the light emission wavelength of the laser element 2 may be appropriately selected according to the types of a phosphor 4 included in the phosphor section 3 and a phosphor 7 included in the phosphor section 6, and may be a wavelength that is different from that of blue.

It should be noted that the laser element 2 may be a light-emitting element that emits excitation light capable of exciting the phosphor 4 included in the phosphor section 3 and the phosphor 7 included in the phosphor section 6, and another excitation light source such as a light-emitting diode (LED) may be used without being restricted to a semiconductor laser.

In the case where the excitation light L1 is laser light (in other words, in the case of the laser element 2), the phosphor section 3 or the phosphor section 6 is irradiated with the excitation light L1 or L2 at a high density and that irradiated region is small, and therefore bright light is emitted from a small region of the surface of the phosphor section 3 or the phosphor section 6. That is, in the case where the excitation light L1 is laser light, it becomes possible for high-luminance light to be emitted from the phosphor section 3 or the phosphor section 6.

In the present embodiment, the irradiation angle of the laser element 2 is adjusted in such a way that the phosphor section 3 is irradiated with the excitation light L1. It is thereby possible for the phosphor section 3 to be irradiated with the excitation light L1 in an efficient manner by the laser element 2. It is preferable that this irradiation angle (beam angle) be an angle formed when a value of 1/e² is attained with respect to the maximum radiant intensity of the excitation light L1, and be an angle that is approximately ±20 degrees or less with the optical axis of the excitation light L1 as the center.

It should be noted that it is possible for the number of laser elements 2 to be selected as appropriate without being restricted to this configuration. For example, in the light-emitting device 1, one laser element 2 may be arranged or two or more laser elements 2 may be arranged.

In addition, part of the excitation light L1 emitted from the laser element 2 passes through the phosphor sections 3 and 6, or scatters in the phosphor sections 3 and 6, and is thereby emitted to outside of the light-emitting device 1. It should be noted that, as depicted in FIG. 1, excitation light L2 constitutes part of the excitation light L1 that has passed through the phosphor section 3 without being converted in the phosphor section 3. Part of that excitation light L2 passes through or scatters in the phosphor section 6, and is thereby emitted to outside of the light-emitting device 1. In other words, part of the excitation light L1 emitted by the laser element 2 is used as outgoing light of the light-emitting device 1.

The phosphor section 3 receives the excitation light L1 emitted from the laser element 2 and emits first fluorescence. In other words, the phosphor section 3 absorbs the excitation light L1 and emits the first fluorescence. Furthermore, the phosphor section 3 converts the excitation light L1 into the first fluorescence, and therefore may be referred to as a wavelength conversion element.

The phosphor section 3 has a light-receiving surface 3R that is irradiated with the excitation light L1 (receives the excitation light L1), and a light-outgoing surface 3E that is a surface on the opposite side to the light-receiving surface 3R. In other words, as depicted in FIG. 1, the excitation light L1 emitted from the laser element 2 is radiated onto the light-receiving surface 3R of the phosphor section 3, and is converted into the first fluorescence by the phosphor section 3. The first fluorescence is then emitted in all directions as viewed from the center of the phosphor section 3, from each surface of the phosphor section 3 including the light-outgoing surface 3E.

The shape of the phosphor section 3 is a columnar shape in FIG. 1 but is not restricted thereto. For example, it is possible for any shape to be adopted such as a planar shape or a cuboid shape as well as a shape such as a rectangular cuboid shape or a sheet shape.

Furthermore, the phosphor section 3 is mainly provided with the phosphor 4 and a sealing material 5.

The phosphor 4 receives the excitation light L1 emitted from the laser element 2 and emits the first fluorescence. The type of the phosphor 4 is selected along with the peak wavelength of the excitation light L1 in such a way that the outgoing light emitted from the light-emitting device 1 has a desired tone. In other words, the first fluorescence is light that is emitted due to the excitation light L1 being absorbed by the phosphor 4, which is selected in such a way that the outgoing light including some excitation light L1 has the desired tone.

In the case where the outgoing light emitted from the light-emitting device 1 is white light (pseudo-white light), for example, it is possible for the white light (pseudo-white light) to be realized with a mixed color of three colors that satisfy a color matching principle, a mixed color of two colors that satisfy a complementary color relationship, or the like. On the basis of this color matching or complementary color principle/relationship, for example, it is possible for the pseudo-white color to be realized by having the excitation light L1 emitted from the laser element 2 as blue and the first fluorescence of the phosphor section 3 as yellow (a mixed color of two colors that satisfy a complementary color relationship).

There may be one type of the phosphor 4 included in the phosphor section 3 or there may be two or more types. For example, in the case where there is to be one type of the phosphor 4, if the phosphor section 3 is to be irradiated with blue excitation light L1 for white light to be emitted from the light-emitting device 1, a yellow light-emitting phosphor can be used as the phosphor 4. Possible examples of a yellow light-emitting phosphor (a phosphor that emits fluorescence having a peak wavelength in the wavelength range of greater than 560 nm to 590 nm or less) are a YAG:Ce phosphor that is a cerium (Ce)-activated yttrium (Y)aluminum (Al) garnet phosphor, an Eu²⁺-doped Caα-SiAlON:Eu phosphor that is an oxynitride-based phosphor (a SiAlON phosphor), and the like.

On the other hand, in the case where there are to be two types of the phosphor 4, if the phosphor section 3 is to be irradiated with blue excitation light L1 for white light to be emitted from the light-emitting device 1, phosphors selected from a green light-emitting phosphor, an orange light-emitting phosphor, and a red light-emitting phosphor can be used. Possible examples of a green light-emitting phosphor (a phosphor that emits fluorescence having a peak wavelength in the wavelength range of 510 nm or more to 560 nm or less) are an Eu²⁺-doped β-SiAlON:Eu phosphor, a Ce³⁺-doped Caα-SiAlON:Ce phosphor, and the like that are oxynitride-based phosphors (SiAlON phosphors). Possible examples of an orange light-emitting phosphor (a phosphor that emits fluorescence having a peak wavelength in the wavelength range of greater than 560 nm to 600 nm or less) are an Eu²⁺-doped Sr₃SiO₅:Eu²⁺ phosphor, a Ca_{0.7}Sr_{0.3}AlSiN₃:Eu²⁺ phosphor, and the like. Possible examples of a red light-emitting phosphor (a phosphor that emits fluorescence having a peak wavelength in the wavelength range of greater than 600 nm to 680 nm or less) are an Eu²⁺-doped CaAlSiN₃:phosphor (a CASN:Eu phosphor), an Eu²⁺-doped SrCaAlSiN₃ phosphor (a SCASN:Eu phosphor), and the like that are nitride-based phosphors.

Furthermore, it is preferable that the size (particle size) of the phosphor 4 be a size with which Mie scattering is caused, and is preferably a size that is equal to or greater than the peak wavelength of the excitation light L1 emitted from the laser element 2, for example. Here, Mie scattering is a light scattering phenomenon that is caused by particles having a particle size that is the same or greater than the peak wavelength of light (the excitation light L1 in the present embodiment) radiated onto a phosphor.

In the case where particles having a particle size that causes Mie scattering are used as the phosphor 4, it is possible to sufficiently withstand light having a strong density, and it is therefore possible to suppress deterioration of the phosphor 4. Thus, a phosphor section 3 having high reliability can be realized. Furthermore, the excitation light L1 is absorbed or Mie-scattered in the phosphor 4, and therefore enters a low excitation density state. Therefore, the phosphor section 6 that includes the phosphor 7, which does not cause Mie scattering and is described later on, is irradiated with excitation light L2 that has a low excitation density compared with the excitation light L1. Thus, the reliability of the phosphor section 6 can be improved.

In other words, in the case where particles that causes Mie scattering are used as the phosphor 4, it is possible to improve the reliability of the phosphor sections 3 and 6 with respect to the excitation light L1. To paraphrase, it is possible to provide phosphor sections 3 and 6 that have high reliability. However, if this point is not to be taken into consideration, it is not absolutely necessary to use particles that cause Mie scattering as the phosphor 4.

The sealing material 5 is for sealing the phosphor 4. Specifically, in the phosphor section 3, the particles of the phosphor 4 are dispersed within the sealing material 5; however, there is no restriction thereto. For example, the phosphor section 3 may be a section in which the particles of the phosphor 4 are fixed without the sealing material 5 being provided, a section in which the particles of the phosphor 4 are deposited on a substrate made of a material having high thermal conductivity, or the like.

The material of the sealing material 5 can be appropriately selected from a resin such as a silicone resin, an acrylic resin (PMMA, PLMA, or the like), and an epoxy resin, or an optically transparent substance such as a glass material, or the like. Furthermore, the sealing material 5 is preferably a material having high optical transparency (transparent, light-transmitting), and is preferably a material having high heat resistance in the case where there is to be a high output of the excitation light L1.

Furthermore, it is preferable that the phosphor 4 be dispersed in a uniform manner within the phosphor section 3. In this case, within the phosphor section 3, the excitation light L1 can be efficiently scattered, and can also be efficiently converted into the first fluorescence. Furthermore, the volume concentration, number of particles, and the like of the phosphor 4 included in the phosphor section 3 may be appropriately specified according to the color temperature or tone of the outgoing light to be emitted from the light-emitting device 1.

The phosphor section 6 receives the excitation light L2 that has not excited the phosphor 4 in the phosphor section 3, is excited by the excitation light L2, and emits second fluorescence. In other words, the phosphor section 6 absorbs, from within the excitation light L1, excitation light L2 that has passed through the phosphor section 3 without being converted into first fluorescence by the phosphor section 3 and emits the second fluorescence.

Similar to the phosphor section 3, the phosphor section 6 has a light-receiving surface 6R that is irradiated with the excitation light L2 (receives the excitation light L2), and a light-outgoing surface 6E that is a surface on the opposite side to the light-receiving surface 6R. In other words, as depicted in FIG. 1, excitation light L2 that has passed through the phosphor section 3 is radiated onto the light-receiving surface 6R of the phosphor section 6, and is converted into second fluorescence by the phosphor section 6. The second fluorescence is then emitted in all directions as viewed from the center of the phosphor section 6, from each surface of the phosphor section 6 including the light-outgoing surface 6E.

The shape of the phosphor section 6 is a columnar shape in FIG. 1 but is not restricted thereto. For example, similar to the phosphor section 3, it is possible for any shape to be adopted such as a planar shape or a cuboid shape as well as a shape such as a rectangular cuboid shape or a sheet shape. However, it is preferable that, from within the excitation light L2 that has passed through the phosphor section 3, a portion having a higher radiant intensity than the first fluorescence have a size that satisfies the <Conditions Regarding the Arrangement of the Phosphor Section 6> described later on (a size that satisfies expression (1)) in order to be reliably incident upon the phosphor section 6.

Furthermore, the phosphor section 6 is mainly provided with the phosphor 7 and a sealing material 8.

The phosphor 7 absorbs the excitation light L2 that has passed through the phosphor section 3 and emits the second fluorescence. Furthermore, the peak wavelength of the second fluorescence emitted from the phosphor 7 is approximate to the peak wavelength of the excitation light L1 emitted from the laser element 2 (in other words, the excitation light L2 that is incident upon the phosphor section 6). Here, the peak wavelength of the second fluorescence and the peak wavelength of the excitation light L1 (or L2) being “approximate” means that these peak wavelengths are substantially the same wavelength, and the second fluorescence and the excitation light L1 are the same color or are colors that are close to each other.

In other words, the second fluorescence is light that has a wavelength range that is wider than that of the excitation light L1, and includes at least part of the wavelength range of the excitation light L1 (or L2). It should be noted that it is not absolutely necessary for the wavelength range of the second fluorescence to include at least part of the wavelength range of the excitation light L1. In other words, the second fluorescence may be light that has a wavelength range that is wider than that of the excitation light L1, and has its wavelength range in the vicinity of the wavelength range of the excitation light L1.

More specifically, if the peak wavelength of the second fluorescence and the peak wavelength of the excitation light L1 (or L2) are in the range of the same color, it can be said that these two peak wavelengths are approximate. For example, in the case where the peak wavelength of the excitation light L1 (or L2) is blue and 450 nm, it is sufficient for the peak wavelength of the second fluorescence to be in the range of blue (435 to 480 nm).

The phosphor 7 may be selected according to the type of excitation light L1 to be emitted from the laser element 2 (in other words, the type of the laser element 2).

An InP-based nanocrystal phosphor can be used as the phosphor 7, for example. When the particle size of InP is reduced, the band gap can be controlled in the range from blue (short wavelength) to red (long wavelength) due to the quantum size effect, and the light emission color can be altered at will. In addition, by optimizing manufacturing conditions, a nanocrystal phosphor having substantially uniform particle sizes is able to be obtained, and it is therefore possible to obtain an emission spectrum having a narrow half-value width.

Alternatively, a nanocrystal phosphor made of a group III-V compound semiconductor other than InP or a group II-VI compound semiconductor may be used as a phosphor material. Possible examples of a nanocrystal phosphor made of a group III-V compound semiconductor, a group II-VI compound semiconductor, or a group III-V compound semiconductor are, in the binary system, CdSe, CdS, ZnS, or the like as a group II-VI compound semiconductor, and InN, InP, or the like as a group III-V compound semiconductor. Furthermore, in the ternary system and quaternary system, possible examples are CdSeS, InNP, CdZnSeS, GaInNP, InGaN, or the like.

It is preferable that a nanocrystal phosphor including In and P be used as the phosphor. The reason therefor being that a nanocrystal phosphor having a particle size with which light is emitted in the visible light region (380 nm to 780 nm) is easy to manufacture, has a high quantum yield, and exhibits high light emission efficiency when irradiated with excitation light. It should be noted that the quantum yield here is the ratio of the number of photons emitted as fluorescence to the number of photons absorbed.

Furthermore, the particle size of the phosphor 7 is preferably a size of an order that does not cause Mie scattering, in other words, is preferably smaller than the peak wavelength of the excitation light L1 (or L2) emitted from the laser element 2. For example, the particle size of the phosphor 7 is preferably equal to or less than 1/50 of the peak wavelength of the excitation light L1.

In this case, it is possible to suppress the excitation light L2 that is incident upon the phosphor section 6 scattering and being emitted from a substantially opposite direction (toward the light-receiving surface 6R that opposes the laser element 2) to the direction of advancement of the excitation light L2 (in other words, the excitation light L2 scattering backward). In other words, it is possible to emit the excitation light L2 that has been scattered by the phosphor 7, from each surface apart from the light-receiving surface 6R, of the phosphor section 6. Therefore, it is possible for the scattered excitation light L2 to be reliably used as part of the outgoing light emitted from the light-emitting device 1, and it is therefore possible to suppress a reduction in the amount of outgoing light.

The sealing material 8 is for sealing the phosphor 7. Similar to the sealing material 5, the material of the sealing material 8 can be appropriately selected from a resin such as a silicone resin, an acrylic resin (PMMA, PLMA, or the like), and an epoxy resin, or an optically transparent substance such as a glass material, or the like.

Furthermore, the phosphor 7 is dispersed in a uniform manner within the phosphor section 6. In this case, similar to the phosphor section 3, within the phosphor section 6, the excitation light L2 can be efficiently scattered, and can also be efficiently converted into the second fluorescence.

The adhesive layer 9 adheres the phosphor section 3 and the phosphor section 6. It is preferable that an acrylic or silicone-based adhesive be used as the material of the adhesive layer 9.

The adhesive layer 9 is formed by, for example, deciding the position where the phosphor section 6 is to be adhered on the phosphor section 3, and then applying the adhesive at said position of the phosphor section 3. Once the adhesive layer 9 has been formed, the phosphor section 6 is adhered to the phosphor section 3 by way of the adhesive layer 9. It should be noted that the adhesive layer 9 does not have to be applied to the phosphor section 3, and may be formed by the adhesive being applied to the light-receiving surface 6R of the phosphor section 6 (the surface opposing the phosphor section 3, the bottom surface of the phosphor section 6).

Furthermore, it is preferable that the values of the refractive indexes of the sealing material 5, the sealing material 8, and the adhesive layer 9 be the same or be values that are close. In this case, it is possible to reduce loss of the excitation light L2 at the interference between the phosphor section 3 and the adhesive layer 9 and the interface between the phosphor section 6 and the adhesive layer 9, and it is therefore possible to increase the utilization efficiency of the excitation light L2 in the phosphor section 6. In other words, it is preferable that the refractive index of the adhesive layer 9 be set in such a way that optical loss of the excitation light L2 does not occur due to the presence of the adhesive layer 9.

In the present embodiment, a description has been given with the adhesive layer 9 being provided between the phosphor section 3 and the phosphor section 6; however, it should be noted that the phosphor section 6 may be provided on the phosphor section 3 in such a way that optical loss of the excitation light L2 due to a difference in refractive indexes between the phosphor sections 3 and 6 and the interface therebetween does not occur, with there being no air or the like present at the interface between the phosphor section 3 and the phosphor section 6, for example. In other words, the phosphor section 6 may be provided on the phosphor section 3 without the adhesive layer 9 being interposed. In this case, the phosphor section 6 may be manufactured by a mixture obtained by mixing an acrylic or silicone-based resin and the phosphor 7 being applied directly to the light-outgoing surface 3E of the phosphor section 3, and then the mixture being subjected to processing such as thermosetting or photocuring.

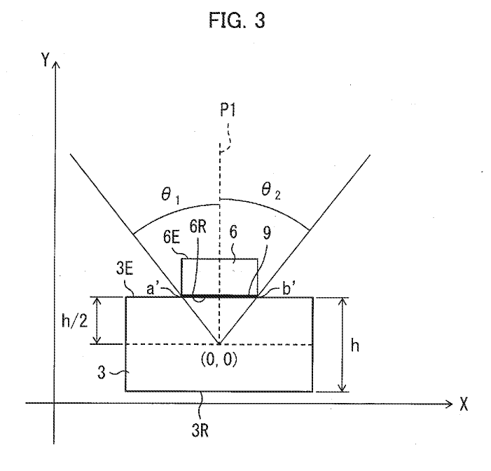

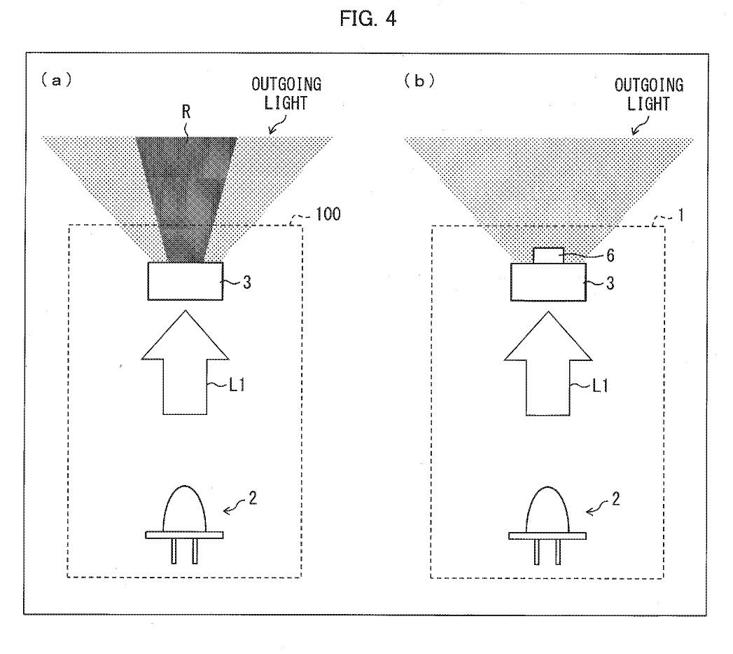

Next, conditions regarding the arrangement of the phosphor section 6 will be described on the basis of FIG. 2 to FIG. 4. FIG. 2 is a graph depicting the light distribution characteristics of excitation light and fluorescence emitted from a light-emitting device 100 depicted in (a) of FIG. 4. FIG. 3 is a schematic cross-sectional view depicting the relative positional relationship of the phosphor sections 3 and 6. FIG. 4 is a schematic diagram depicting the difference between outgoing light from the light-emitting device 1 and outgoing light from the light-emitting device 100, (a) depicts the way in which outgoing light is emitted from the light-emitting device 100, and (b) depicts the way in which outgoing light is emitted from the light-emitting device 1.

It should be noted that the light-emitting device 100 is a comparative example of the light-emitting device 1 (a comparative example for indicating the utility of the phosphor section 6), and is provided with the laser element 2 and the phosphor section 3. In other words, the light-emitting device 100 is different from the light-emitting device 1 in not being provided with the phosphor section 6. Furthermore, in FIG. 2, the horizontal axis is the irradiation angle of the excitation light and the fluorescence. The vertical axis is the radiant intensity of the excitation light and the fluorescence.

It is preferable that the phosphor section 6 be provided on the light-outgoing surface 3E of the phosphor section 3 (the side from which the excitation light L2 is emitted) as depicted in FIG. 1 and FIG. 3 in order for the excitation light L2 that has not been converted into first fluorescence by the phosphor section 3 to be efficiently converted into second fluorescence (condition 1).

Furthermore, it is preferable that the length of the bottom side of the light-receiving surface 6R (the surface that adheres to the phosphor section 3 (the adhesive layer 9)) of the phosphor section 6 and the arrangement position on the light-outgoing surface 3E of the phosphor section 3 be specified (condition 2). Hereinafter, condition 2 that indicates the length of that bottom side and the arrangement position on the light-outgoing surface 3E of the phosphor section 3 will be described.

First, the length of the bottom side of the phosphor section 6 will be described. As depicted in FIG. 2, intersecting points between a graph (solid line) of the light distribution characteristics of excitation light L1 and a graph (dotted line) of the light distribution characteristics of first fluorescence in the light-emitting device 100 are taken as intersecting points a and b. The intersecting points a and b are locations where the radiant intensities of the excitation light L1 and the first fluorescence are equal. Furthermore, in FIG. 2, the irradiation angle 0° is substantially coincident with the optical axis of the light-emitting device 100 (or the light-emitting device 1).

Furthermore, as depicted in FIG. 2, when the light distribution characteristics of the first fluorescence are compared with the light distribution characteristics of the excitation light L1, the radiant intensity of the excitation light L1 is higher than the radiant intensity of the first fluorescence between the intersecting points a and b (irradiation angles θ1 to θ2), whereas the radiant intensity of the excitation light L1 is lower than the radiant intensity of the first fluorescence at irradiation angles −90° to θ1 and θ2 to +90°.

Therefore, in the case where the excitation light L1 is not completely scattered in the phosphor section 3 and passes through the phosphor section 3, the outgoing light emitted from the light-emitting device 100 is affected by a portion in which the radiant intensity of the excitation light L1 is stronger than the radiant intensity of the first fluorescence (in other words, the radiant intensity of the excitation light L1 that is emitted within the range of the irradiation angles θ1 to θ2). Therefore, as depicted in (a) of FIG. 4, the tone of a central region R of the outgoing light of the light-emitting device 100 intensifies and a color irregularity occurs in the outgoing light. In order to reduce this color irregularity, it is necessary for the excitation light L1 that has the radiant intensity between the intersecting points a and b (the excitation light L1 that is emitted at the irradiation angles θ1 to θ2) to be made to be incident upon the phosphor section 6.

Here, in FIG. 3, with respect to the dotted line (vertical line P1 in the thickness direction of the phosphor section 3 (the central axis of the light-outgoing surface 3E)) that is drawn parallel to the Y axis through the center (taken as the origin (0, 0) of the phosphor section 3), an irradiation angle is specified with, when said center is taken as a rotation axis, the clockwise direction being taken as the positive direction and the counterclockwise direction being taken as the negative direction. This irradiation angle indicates a solid angle that is formed by the excitation light L1 or the first fluorescence when the excitation light L1 or the first fluorescence is emitted from the center of the phosphor section 3.

In FIG. 2, it is indicated that the irradiation angle θ1 corresponding to the intersecting point a is a negative value, and the irradiation angle θ2 corresponding to the intersecting point b is a positive value. Furthermore, the irradiation angles θ1 and θ2 are obtained by measuring the excitation light L1 and the first fluorescence when the excitation light L1 is radiated onto the phosphor section 3 in such a way that the optical axis of the excitation light L1 is substantially coincident with the center of the phosphor section 3 in the light-emitting device 100.

In order to reduce a color irregularity of the outgoing light such as that mentioned above in the light-emitting device 1, it is preferable that a large portion of the excitation light L2, which constitutes part of the excitation light L1 emitted at the irradiation angles θ1 to θ2, be made to be incident upon the phosphor section 6. Therefore, it is preferable that, when the height of the phosphor section 3 is taken as h as depicted in FIG. 3 and the length of the bottom side of the phosphor section 6 is taken as I, the length I of the bottom side of the phosphor section 6 be taken as:

I=2(tan θ1+tan θ2)/h (1)

In other words, it is preferable that a phosphor section 6 that has a light-receiving surface 6R having a bottom side length specified according to the abovementioned expression (1) be adhered to the phosphor section 3.

Next, the position where the phosphor section 6 is arranged will be described. In order for the excitation light L2, which constitutes part of the excitation light L1 emitted at the irradiation angles θ1 to θ2, to be made to be incident upon the phosphor section 6, it is preferable that, in a state in which the phosphor section 6 is arranged on the phosphor section 3, the coordinates a′ and b′ indicating the position of the bottom surface of the light-receiving surface 6R of the phosphor section 6 on the light-outgoing surface 3E of the phosphor section 3 be:

a′(2 tan θ1/h,h/2) (2)

b′(2 tan θ2/h,h/2) (3)

In other words, in the case where the excitation light L1 is radiated onto the phosphor section 3 in such a way that the optical axis of the excitation light L1 passes through in the proximity of the vertical line P1, it is preferable that the phosphor section 6 be arranged at positions (coordinates) a′ and b′ on the light-outgoing surface 3E of the phosphor section 3.

By arranging the phosphor section 6 on the phosphor section 3 in such a way that the abovementioned condition 1 and condition 2 are satisfied, the excitation light L2 can be made to be incident upon the phosphor section 6 in an efficient manner. Thus, in the phosphor section 6, the excitation light L2 that has passed through the phosphor section 3 can be converted into second fluorescence or scattered in an efficient manner.

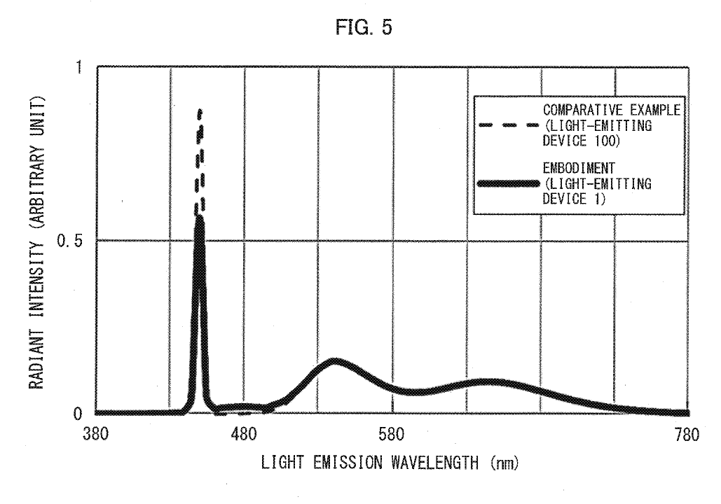

Next, the emission spectra of the outgoing light emitted from the light-emitting devices 1 and 100 will be described using FIG. 5. FIG. 5 is a drawing depicting an example of experiment results indicating the relationship between the light emission intensity and wavelengths of outgoing light emitted from the light-emitting devices 1 and 100. In FIG. 5, the curved line indicated by the dotted line represents the emission spectrum of outgoing light from the light-emitting device 100, and the curved line indicated by the solid line represents the emission spectrum of outgoing light from the light-emitting device 1.

In the present experiment, the same components are used for the laser element 2 and the phosphor section 3 provided in each of the light-emitting devices 1 and 100. The laser element 2 outputs excitation light L1 having a peak wavelength of 450 nm. The phosphor section 6 of the light-emitting device 1 is arranged on the phosphor section 3 in such a way as to satisfy the abovementioned condition 1 and condition 2. Furthermore, InP constituting a nanoparticle phosphor is used as the phosphor 7. The InP used here has the properties of a light emission peak wavelength of 480 nm, a half-value width of 60 nm, and a quantum efficiency of 60%.

Furthermore, the phosphor section 6 absorbs approximately 50% of the portion of the excitation light L2 that is incident upon the phosphor section 6 (approximately 35% of the total quantity of the excitation light L2), and converts this into second fluorescence. To paraphrase, the output of the laser element 2 and the composition and size of the phosphor section 6 are adjusted in such a way that approximately 35% of the excitation light L2 can be absorbed.

First, the case where the light-emitting device 100 is irradiated with excitation light L1 will be described. In the present experiment, the phosphor section 3 is irradiated with excitation light L1, and part of the excitation light and first fluorescence are emitted as outgoing light from the phosphor section 3. As depicted in FIG. 5, light having extremely high light emission intensity (radiant intensity) in the proximity of the wavelength of approximately 450 nm is measured as part of the outgoing light. This indicates that part of the excitation light L1 has passed through the phosphor section 3 as is in a concentrated manner. Therefore, the outgoing light emitted from the light-emitting device 100 is affected by this portion of the excitation light L1 having an extremely high light emission intensity, and, as depicted in (a) of FIG. 4, a color irregularity occurs in the outgoing light.

Next, the case where the light-emitting device 1 provided with the phosphor section 6 is irradiated with excitation light L1 will be described. In the present experiment, the phosphor section 3 is irradiated with excitation light L1 and first fluorescence that has been converted in the phosphor 4 is emitted from the phosphor section 3, and also excitation light L2 that has not been converted into the first fluorescence in the phosphor section 3 is radiated onto the phosphor section 6 and converted into second fluorescence. The excitation light L1 and L2, first fluorescence, and second fluorescence are emitted as outgoing light.

As depicted in FIG. 5, in the light-emitting device 1 also, light having a high light emission intensity in the proximity of the wavelength of approximately 450 nm is measured as part of the outgoing light; however, that light emission intensity has decreased from approximately 0.9 to approximately 0.6. This is because, in the light-emitting device 100, the excitation light L1 that has passed through the phosphor section 3 becomes part of the outgoing light as is, whereas in the light-emitting device 1, the excitation light L1 that has passed through (in other words, the excitation light L2) is converted into second fluorescence having a wider wavelength range than that of the excitation light L1, in the phosphor 7 of the phosphor section 6.

Furthermore, light having a wavelength in the proximity of 480 nm, which is in the vicinity of 450 nm constituting the peak wavelength of the excitation light L1, is measured as part of the outgoing light. In other words, the light emission intensity in the proximity of the wavelength of 480 nm becomes higher than in the case of the light-emitting device 100 serving as a comparative example. This is because a second fluorescence having a wavelength range that includes 480 nm is emitted as a result of using InP, which has a light emission peak wavelength of 480 nm, as the phosphor 7.

That is, as depicted in FIG. 5, it is understood that the emission spectrum of the outgoing light of the light-emitting device 1 is broader than the emission spectrum of the light-emitting device 100. Furthermore, in the light-emitting device 1, the emission spectrum caused by the phosphor 7 is measured between the emission spectrum of the excitation light L1 or L2 in the proximity of 450 nm and the emission spectrum of the first fluorescence having a longer wavelength than 500 nm. Therefore, the color rendering properties of the outgoing light emitted from the light-emitting device 1 can be improved.

Next, the color rendering properties of the outgoing light emitted from the light-emitting device 1 will be described in comparison with the light-emitting device 100. In the present experiment, results were obtained indicating an average color rendering evaluation index Ra of 70 and a special color rendering evaluation index R14 (tree leaf color) of 71 for the outgoing light emitted from the light-emitting device 100.

Here, the color rendering evaluation index expresses, as an index, a color shift that is caused when a color chip for a color rendering evaluation is illuminated by a light source that is to be measured for comparison with reference light determined by the JIS (Japan Industrial Standards). The average color rendering evaluation index Ra is a value obtained by averaging the color rendering evaluation index for eight colors. Furthermore, the special color rendering evaluation index R14 (tree leaf color) is one type of special color rendering evaluation index, and is a value for the color rendering evaluation index of a tree leaf color.

On the other hand, regarding the emission spectrum of the outgoing light emitted from the light-emitting device 1, results were obtained indicating an average color rendering evaluation index Ra of 73 and a special color rendering evaluation index R14 (tree leaf color) of 78. In other words, in the light-emitting device 1, due to being provided with the phosphor section 6, the average color rendering evaluation index Ra improved three points and the special color rendering evaluation index R14 (tree leaf color) improved seven points compared with the light-emitting device 100. In particular, the value for the special color rendering evaluation index R14 (tree leaf color) greatly improved, and therefore it can be said that the light-emitting device 1 can be suitably used for admiring plants.

As described above, the light-emitting device 1 according to the present embodiment is provided with the phosphor section 3, which absorbs excitation light L1 emitted from the laser element 2 and emits first fluorescence, and the phosphor section 6, which absorbs excitation light L2 that has passed through the phosphor section 3 without being converted into first fluorescence by the phosphor section 3 and emits second fluorescence.

In the case of the abovementioned configuration, the excitation light L2 that has passed through the phosphor section 3 is absorbed in the phosphor section 6, and therefore the radiant intensity of the excitation light L2 that is emitted from the phosphor section 6 is able to be reduced. Furthermore, excitation light L2 having strong directivity is converted into second fluorescence by the phosphor section 6, and therefore the second fluorescence is able to be emitted over a wider range than the excitation light L2. This means that, from within the excitation light L1, excitation light in the proximity of a portion having a high radiant intensity (the portion surrounded by the dotted line in FIG. 2) is absorbed and supplements portions having a low radiant intensity (in other words, in the directions of the arrows in FIG. 2). That is, due to the provision of the phosphor section 6, it is possible for the light distribution characteristics of the excitation light L1 to be made to be light distribution characteristics that have width, as with the light distribution characteristics of the first fluorescence.

Furthermore, the peak wavelength of the second fluorescence is approximate to the peak wavelength of the excitation light L1. Due to these two peak wavelengths being approximate, a tone that is the same as or close to the tone of the excitation light L1 (or L2) can be realized with the second fluorescence.

In this way, it is possible for the light-emitting device 1 to emit, instead of part of the excitation light L1, second fluorescence having the same tone as the excitation light L1. Therefore, as depicted in (b) of FIG. 4, it is possible to suppress the occurrence of a color irregularity in the outgoing light emitted from the light-emitting device 1.

Furthermore, in the light-emitting device 1, the occurrence of a color irregularity is suppressed due to the provision of the phosphor section 6 instead of using a scattering agent in the phosphor section 3. Thus, in the light-emitting device 1, it is possible to prevent a decline in the utilization efficiency of the excitation light L1, and it is also possible to suppress the occurrence of a color irregularity in outgoing light. To paraphrase, it is possible to alter the light distribution characteristics of outgoing light.

In addition, the wavelength range of the second fluorescence is wider than the wavelength range of the excitation light L1 (or L2). Therefore, as depicted in FIG. 5, the region between the spectrum of the first fluorescence and the spectrum of the excitation light L1 can be filled in by the second fluorescence. Therefore, the color rendering properties of the outgoing light emitted from the light-emitting device 1 can be improved.

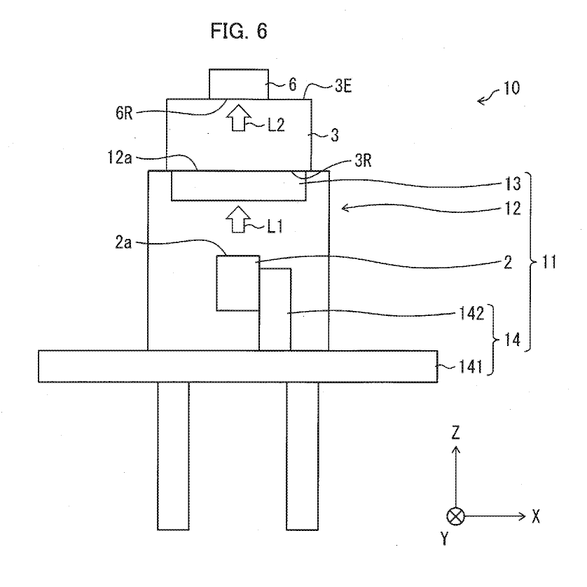

Another embodiment of the present invention is as follows when described on the basis of FIG. 6. It should be noted that, for convenience of the description, members having the same functions as the members described in the aforementioned embodiment are denoted by the same reference signs and descriptions thereof are omitted.

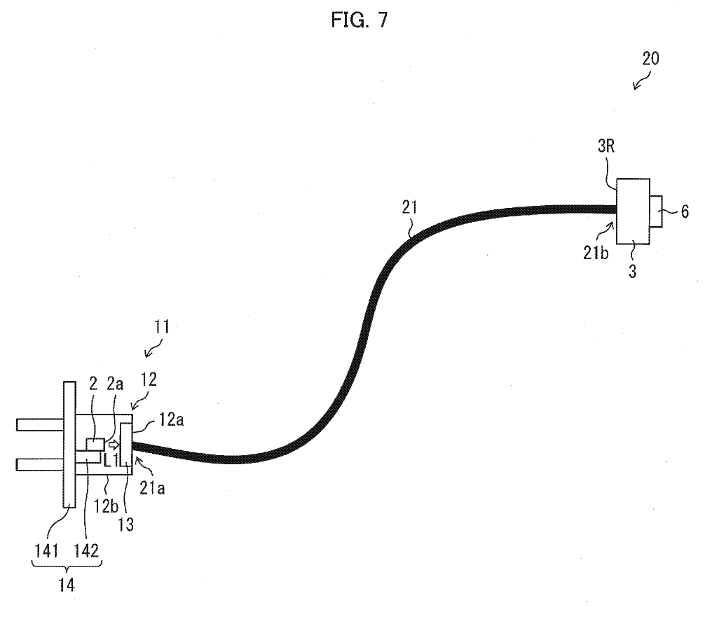

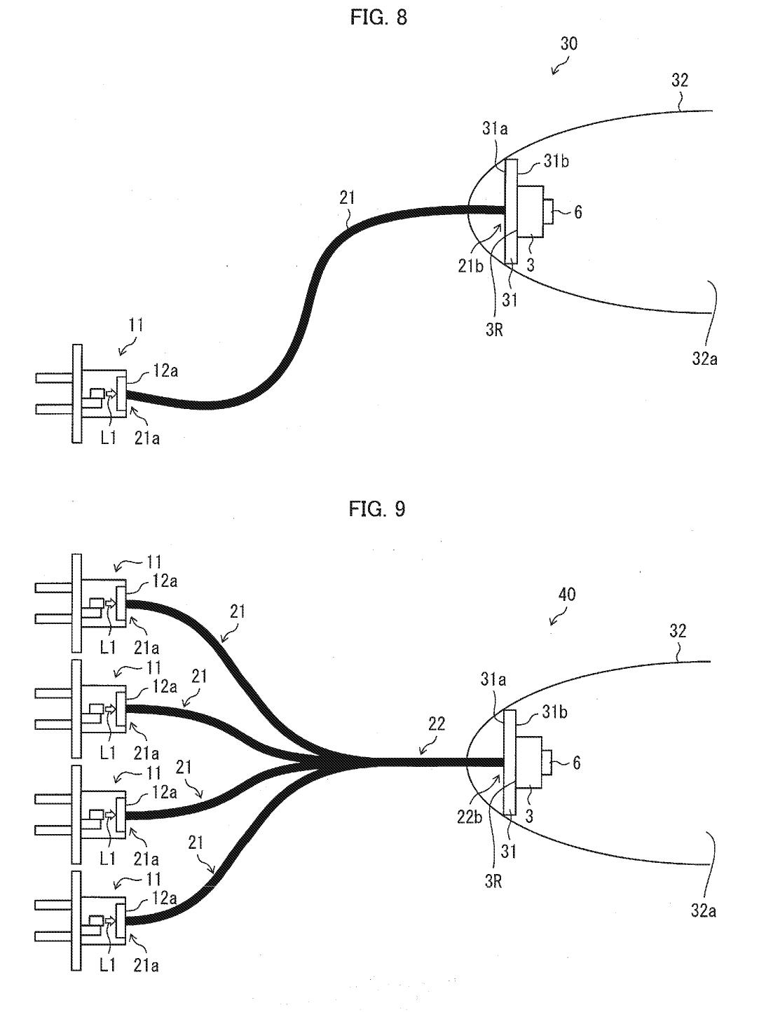

FIG. 6 is a cross-sectional view depicting the schematic configuration of a light-emitting device 10 according to an embodiment of the present invention. In FIG. 6, the light-emitting device 10 represents an example of the relative arrangement relationship between the laser element 2 and the phosphor sections 3 and 6 in the light-emitting device 1. The light-emitting device 10, as depicted in FIG. 6, is provided with the phosphor section 3, the phosphor section 6, and a light source unit 11. It should be noted that the adhesive layer 9 is formed between the phosphor sections 3 and 6; however, the depiction of the adhesive layer 9 is omitted in FIG. 6 (the same is also true for FIG. 7 and FIG. 8). Hereinafter, each member will be described.

The phosphor section 3 is the same as that described in embodiment 1. As depicted in FIG. 6, the phosphor section 3 is arranged on (in the +Z direction depicted in FIG. 6) a cap 12 described later on. In the present embodiment, the phosphor section 3 is arranged on the cap 12 in such a way that the central axis (the vertical line P1 depicted in FIG. 3) of the light-receiving surface 3R of the phosphor section 3 is substantially coincident with the central axis of an upper surface 12a of the cap 12. Furthermore, the phosphor section 3 is arranged so as to cover a glass sheet 13 that is installed on the cap 12. It is thereby possible to prevent excitation light L1 from leaking out directly from the glass sheet 13.

The phosphor section 3 is irradiated with excitation light L1 that has passed through the glass sheet 13, which is described later on. The excitation light L1 is then converted by the abovementioned phosphor 4, and the abovementioned first fluorescence is emitted from the phosphor section 3.

The phosphor section 6 is the same as that described in embodiment 1. Furthermore, the relative positional relationship of the phosphor sections 3 and 6 is the same as in embodiment 1. In the present embodiment, the phosphor section 6 is arranged on the phosphor section 3 in such a way that the central axis (the vertical line P1 depicted in FIG. 3) of the light-outgoing surface 3E of the phosphor section 3 and the central axis of the light-receiving surface 6R of the phosphor section 6 are substantially coincident.

The phosphor section 6 is irradiated with excitation light L2 that has not been converted into first fluorescence by the phosphor section 3. The excitation light L2 is then converted by the phosphor 7, and the abovementioned second fluorescence is emitted from the phosphor section 6.

The light source unit 11 irradiates the phosphor sections 3 and 6 with excitation light L1 (or L2). The light source unit 11 is provided with the laser element 2, the cap 12, the glass sheet 13, and a stem 14.

The laser element 2 is the same as that described in embodiment 1. The laser element 2 is arranged in a substantially central section in the width direction (the X direction and Y direction depicted in FIG. 6) within the cap 12. Furthermore, the laser element 2 is provided with a light-outgoing surface 2a from which excitation light L1 is emitted, on the upper surface thereof (the +Z direction depicted in FIG. 6), and is positioned away from the cap 12 in such a way that the light-outgoing surface 2a opposes the upper surface 12a of the cap 12.

Furthermore, the emission optical axis of the laser element 2 substantially overlaps the central axis of the upper surface 12a of the cap 12. The central axis of the excitation light L1 emitted from the laser element 2 can be said to also be substantially coincident with the central axis of the light-emitting device 10. That is, the relative positional relationship with the phosphor sections 3 and 6 of the laser element 2 within the cap 12 is determined in such a way that the emission optical axis of the laser element 2 is substantially coincident with the central axis of the upper surface 12a of the cap 12, the central axis of the light-receiving surface 3R of the phosphor section 3, and the central axis of the light-receiving surface 6R of the phosphor section 6. It is thereby possible for excitation light L2 that has passed through the phosphor section 3 to be reliably captured in the phosphor section 6.

It should be noted that the light-outgoing surface 2a in the present embodiment does not only mean that excitation light L1 is emitted from the entire surface thereof, but also includes excitation light L1 being omitted from part of the surface. In addition, although not depicted, it is possible for the laser element 2 to be electrically connected to a lead via a wire or the like, and to thereby be connected to an external electrode.

The cap 12 is for ensuring that excitation light L1 emitted from the laser element 2 does not leak to outside of the light-emitting device 10. Specifically, the cap 12 is a cylindrically shaped member having light-shielding properties with respect to the excitation light L1, and the glass sheet 13 is installed on the upper surface 12a thereof; in other words, a configuration in which excitation light L1 emitted from the laser element 2 is able to pass through only the glass sheet 13. The cap 12 is thereby able to have excitation light L1 that is emitted from the laser element 2 provided therein reliably irradiated onto the phosphor section 3 that is arranged on the upper surface 12a thereof, and is also able to prevent the excitation light L1 leaking to outside of the cap 12.

The shape of the cap 12 is not restricted to that depicted in FIG. 6 provided that it is possible for the laser element 2 to be sealed. In other words, the shape of the cap 12 is not restricted to a cylindrical shape, and it is sufficient to have a configuration with which it is possible for the laser element 2 to be provided therein and to ensure that excitation light L1 does not leak out from a location other than the glass sheet 13. For example, in the case where a stem base section 141 that forms part of the stem 14 described later on has a substantially cylindrical shape having a cavity therein, it is also possible for the cap 12, which occludes the upper section thereof, to be substantially disk-shaped.

Furthermore, it is preferable that the material of the cap 12 have high thermal conductivity. Thus, in the case where the phosphor section 3 is fixed to the cap 12, it is possible for heat generated from the phosphor section 3 to be dissipated. Specifically, heat emitted from the phosphor section 3 propagates to the cap 12, additionally propagates to the stem base section 141 via the side surfaces of the cap 12, and is dissipated. That is, heat emitted from the phosphor section 3 is transmitted to the stem base section 141 via the cap 12.

In order to increase the abovementioned heat dissipation effect, possible examples of the material of the cap 12 are cold-rolled steel sheet (SPC), an iron-nickel-cobalt alloy (Kovar), aluminum, copper, brass, or a ceramic-based material such as alumina, aluminum nitride, or SiC.

Furthermore, the cap 12 is adhered to the stem base section 141 at the lower section of the cap 12. Therefore, the material of the cap 12 may be determined with consideration being given to the degree of adhesion to the material of the stem base section 141. Specifically, the degree of adhesion increases with an iron-based material such as Kovar, nickel, or stainless steel (SUS) as the material of the cap 12.

The glass sheet 13 has excitation light L1 that is emitted from the laser element 2 pass therethrough to the phosphor section 3. The glass sheet 13 is installed on the upper surface 12a of the cap 12, and closes an opening in the upper surface 12a. Furthermore, the surface of the glass sheet 13 is larger than the light-receiving surface 3R of the phosphor section 3. Therefore, the glass sheet 13 is able to cover the entirety of the light-receiving surface 3R of the phosphor section 3, and is able to protect the phosphor section 3 from being directly irradiated with excitation light L1. The glass sheet 13 is made of a material having excellent optical transparency such as a silicon oxide such as quartz or glass for example, or an aluminum oxide such as sapphire. In other words, it is preferable that the material installed on the upper surface 12a be a material having transparency with respect to the excitation light L1.

The stem 14 supports the laser element 2 and the cap 12. The stem 14 is provided with the stem base section 141 and a stem columnar body 142.

The stem base section 141 is a stand on which the cap 12 is mounted. The stem base section 141 has arranged thereon the stem columnar body 142, which serves as a support member to which the laser element 2 is fixed, in order to specify the relative positional relationship of the laser element 2 within the cap 12 with the phosphor section 3. The laser element 2 is mounted on a side surface of the stem columnar body 142 by way of an adhesive material such as Au—Sn, for example. It is thereby possible to arrange the laser element 2 inside the cap 12 in such a way that, in a state in which the cap 12 has been mounted, the emission optical axis of the laser element 2 and the central axis of the light-receiving surface 3R of the phosphor section 3 are substantially coincident. In the present embodiment, as depicted in FIG. 6, the stem columnar body 142 is installed in a position that is eccentric in the circumferential direction from the central section of the stem base section 141.

It should be noted that the stem base section 141 and the stem columnar body 142, for convenience, have been individually named according to location and are not necessarily different members. It is also possible for both to be implemented as the same member, and the number of product parts can thereby be reduced.

Similar to the cap 12, it is preferable that the material of the stem 14 have high thermal conductivity so that heat generated in the laser element 2, the phosphor section 3, and the like can be dissipated. Specifically, possible examples are copper, brass, tungsten, aluminum, a copper-tungsten alloy, or the like.

For example, when heat generated during use of the laser element 2 is accumulated inside the laser element 2, the characteristics thereof deteriorate and the lifespan becomes shorter. In the case of the abovementioned materials, heat generated from the laser element 2 is conducted to the stem columnar body 142 and the stem base section 141 which are mechanically and electrically connected to the laser element 2, and is emitted into the outside air. Furthermore, as mentioned above, heat generated in the phosphor section 3 is also emitted into the outside air from the stem base section 141 through the cap 12. That is, the stem 14 is able to perform the role of a heat sink when made of the abovementioned materials.

Furthermore, it is preferable that the material of the stem base section 141 have high light-shielding properties with respect to the excitation light L1 so that the excitation light L1 does not leak out from a location other than the glass sheet 13. In addition, the material stem base section 141 may be determined with consideration being given to the material of the cap 12 and adhesion with the cap 12.

The shape of the stem 14 is not restricted to that depicted in FIG. 6 provided that it is possible for the laser element 2 to be sealed. In other words, it is sufficient to have a configuration with which it is possible for the laser element 2 to be arranged inside the cap 12 and to ensure that excitation light L1 does not leak out from the stem 14.

The light-emitting device 10 has a configuration in which the laser element 2 is covered by the cap 12, and therefore, in addition to the effect of the light-emitting device 1, it is possible to prevent excitation light L1 being emitted to outside of the light-emitting device 10. Thus, it is possible to increase safety as a light-emitting device.

Furthermore, in the case where materials having high thermal conductivity are selected as the materials of the cap 12 and the stem 14, heat that is emitted from the laser element 2 can be dissipated via the stem 14. In addition, heat that is emitted from the phosphor section 3 can be dissipated from the stem 14 via the cap 12. That is, separate heat sink materials are provided for different heat sources, and therefore these can be efficiently dissipated.

Another embodiment of the present invention is as follows when described on the basis of FIG. 7. It should be noted that, for convenience of the description, members having the same functions as the members described in the aforementioned embodiment are denoted by the same reference signs and descriptions thereof are omitted.

FIG. 7 is a cross-sectional view depicting the schematic configuration of a light-emitting device 20 according to an embodiment of the present invention. As depicted in FIG. 7, the light-emitting device 20 has a configuration in which excitation light L1 that is emitted from the light source unit 11 is guided to the phosphor sections 3 and 6 by an optical fiber 21 (light guide member). The light-emitting device 20 is provided with the phosphor section 3, the phosphor section 6, the light source unit 11, and the optical fiber 21. Hereinafter, each member will be described.

The phosphor section 3 is the same as that described in embodiment 1. As depicted in FIG. 7, the phosphor section 3 is connected to the optical fiber 21, which is described later on. Specifically, the phosphor section 3 is optically connected to the optical fiber 21 in such a way that the light-receiving surface 3R of the phosphor section 3 and an outgoing end section 21b of the optical fiber 21 oppose each other.

The phosphor section 6 is the same as that described in embodiment 1. Furthermore, the relative positional relationship between the phosphor section 3 and the phosphor section 6 is the same as in embodiment 1.

(Light Source Unit 11)

The light source unit 11 is the same as that described in embodiment 2. The light source unit 11 is optically connected to the optical fiber 21 in such a way that the upper surface 12a of the cap 12 and an incoming end section 21a of the optical fiber 21 oppose each other. In FIG. 7, there is one light source unit 11; however, there may be a plurality. It should be noted that a configuration in which the light source unit 11 is provided in plurality is described later on using FIG. 9.

The optical fiber 21 is a light guide member that guides excitation light L1 emitted from the light source unit 11 to the phosphor section 3, and is provided with the incoming end section 21a and the outgoing end section 21b.

The incoming end section 21a is a section that receives excitation light L1 emitted from the light source unit 11 (a section upon which the excitation light L1 is incident). It is preferable that the incoming end section 21a be arranged opposing the glass sheet 13 in such a way that the central axis of the optical fiber 21 is substantially coincident with the emission optical axis of the laser element 2. It is thereby possible to prevent the excitation light L1 from leaking out from an outer peripheral section of the incoming end section 21a. Furthermore, the cross section of the incoming end section 21a may be wider than the cross section of other sections of the optical fiber 21, and the proximity of the outer periphery of the incoming end section 21a may be sealed with a sealing material having high light-shielding properties with respect to excitation light L1.

The outgoing end section 21b is a section from which excitation light L1 that has been received by the incoming end section 21a and has passed through the optical fiber 21 is emitted to the phosphor section 3. It is preferable that the outgoing end section 21b be arranged opposing the light-receiving surface 3R in such a way that the central axis of the optical fiber 21 is substantially coincident with the central axis of the light-receiving surface 3R of the phosphor section 3. Similar to embodiment 1, it is thereby possible for excitation light L2 that has passed through the phosphor section 3 to be made to be reliably incident upon the phosphor section 6.

Furthermore, a quartz fiber having a core diameter of 400 μm or less can be used as the optical fiber 21, for example. Furthermore, not only a quartz fiber but also a fiber made of a plastic material can be used for the optical fiber 21.

In addition, the optical fiber 21 is flexible, and therefore the relative positional relationship between the laser element 2 and the phosphor section 3 can be easily altered, and by adjusting the length thereof, the laser element 2 can be installed in a position away from the phosphor section 3. Thus, the degree of design freedom of the light-emitting device 20 can be increased with, for example, it being possible to install the laser element 2 in an easy-to-cool position or an easy-to-replace position.

Furthermore, due to the optical fiber 21, the phosphor sections 3 and 6 and the light source unit 11 can be provided away from each other. It is therefore possible to prevent heat that is emitted from the light source unit 11 from propagating to the phosphor sections 3 and 6, and it is therefore possible to suppress a decline in the efficiency of the conversion to first fluorescence by the phosphor 4 or to second fluorescence by the phosphor 7 and deterioration of the phosphors 4 and 7 caused by the heat.

Hereinabove, the optical fiber 21 has been described with there being one thereof; however, it should be mentioned that there may be a bundle of a plurality of optical fibers.

The light-emitting device 20 has a configuration in which the phosphor section 3 is irradiated with excitation light L1 from the light source unit 11 via the optical fiber 21, and therefore, in addition to the effect of the light-emitting device 1, it is possible to prevent the phosphor sections 3 and 6 from being affected by heat emitted from the light source unit 11. Thus, it is possible to suppress a decline in the efficiency of the conversion to first fluorescence or second fluorescence and deterioration of the phosphor sections 3 and 6.

Furthermore, since the phosphor sections 3 and 6 and the light source unit 11 are provided away from each other due to the optical fiber 21, heat generated in the phosphor sections 3 and 6 does not propagate to the light source unit 11. It is therefore possible to suppress deterioration of the laser element 2 due to the heat.

Another embodiment of the present invention is as follows when described on the basis of FIG. 8. It should be noted that, for convenience of the description, members having the same functions as the members described in the aforementioned embodiment are denoted by the same reference signs and descriptions thereof are omitted.

FIG. 8 is a cross-sectional view depicting the schematic configuration of a light-emitting device 30 according to an embodiment of the present invention. As depicted in FIG. 8, the light-emitting device 30 has a configuration in which light emitted from the phosphor sections 3 and 6 is reflected in a reflector 32 (reflection mirror). The light-emitting device 30 is provided with the phosphor section 3, the phosphor section 6, the light source unit 11, the optical fiber 21, a support substrate 31, and the reflector 32. Hereinafter, each member will be described.

The phosphor section 3 is the same as that described in embodiment 1. The phosphor section 3 is arranged on a mounting surface 31b, which opposes a light-receiving surface 31a that it is optically connected to the optical fiber 21, of the support substrate 31 described later on. Although not depicted, the phosphor section 3 is, for example, fixed on the support substrate 31 by an acrylic heat resistant transparent adhesive or the like.

The phosphor section 6 is the same as that described in embodiment 1. Furthermore, the relative positional relationship between the phosphor section 3 and the phosphor section 6 is also the same as in embodiment 1.

The optical fiber 21 is the same as that described in embodiment 3. The outgoing end section 21b of the optical fiber 21 is optically connected to the support substrate 31 in such a way as to oppose the light-receiving surface 31a of the support substrate 31 described later on.

The support substrate 31 is a support member on which the phosphor section 3 is mounted, and, for example, is a material having high thermal conductivity such as sapphire, and high transparency with respect to excitation light L1. For example, a substrate made of sapphire having a thermal conductivity of 42 W/(m·K) at an air temperature of 20° C. can be used as the support substrate 31.

The support substrate 31 has the light-receiving surface 31a, upon which excitation light L1 from the optical fiber 21 is incident, and the mounting surface 31b, on which the phosphor section 3 is mounted. The outgoing end section 21b of the optical fiber 21 is arranged so as to oppose the light-receiving surface 31a and the phosphor section 3 is mounted on the mounting surface 31b in such a way that the central axis of the optical fiber 21 is substantially coincident with the central axis of the light-receiving surface 3R of the phosphor section 3.

Furthermore, as depicted in FIG. 8, end sections of the support substrate 31 are connected to the reflector 32, and the support substrate 31 is thereby supported by the reflector 32. It is preferable that the supported position of the support substrate 31 be arranged in such a way that the light emission center (a position that is on the central axis of the light-outgoing surface 3E of the phosphor section 3 and is half of the total height obtained by totaling the height of the phosphor section 3 and the height of the phosphor section 6) when the phosphor section 3 and the phosphor section 6 for example are treated as a single unit be substantially coincident with a focus position of the reflector 32. In this case, light emitted from the phosphor sections 3 and 6 can be efficiently emitted from an opening section 32a in the reflector 32. It should be noted that, if this point is not to be taken into consideration, it is preferable that the position of the support substrate 31 with respect to the reflector 32 be determined in such a way that the phosphor sections 3 and 6 are provided at least inside the reflector 32.

In this way, due to the phosphor section 3 being mounted on the support substrate 31, heat that is emitted from the phosphor section 3 can be efficiently conducted to the reflector 32 and dissipated.

Furthermore, the shape of the support substrate 31 is, for example, a shape (for example, a circular shape) that is substantially coincident with a cross-section shape (the shape of a plane parallel with the opening section 32a) of the reflector 32. There is no restriction thereto, and a rectangular shape for example is permissible provided that it is a shape with which it is possible to be supported by the reflector 32 and for the phosphor section 3 to be mounted.

Although not depicted, it should be noted that the support substrate 31 may be provided with a heat dissipation fin. This heat dissipation fin functions as a cooling unit that cools the support substrate 31. The heat dissipation fin has a plurality of heat dissipation plates and the contact area with atmospheric air is increased, thereby increasing heat dissipation efficiency. It is sufficient for the cooling unit that cools the support substrate 31 to have a cooling (heat dissipating) function, and the cooling unit may be a heat pipe instead of the heat dissipation fin.

The reflector 32 is a member that reflects light emitted from the phosphor sections 3 and 6. To paraphrase, the reflector 32 is a member that receives and reflects excitation light L1 and first fluorescence emitted from the phosphor section 3 and excitation light L2 and second fluorescence emitted from the phosphor section 6, thereby forming a pencil of rays that advance within a predetermined solid angle, and projecting light from the opening section 32a. This reflector 32 is, for example, a member having a curved surface shape (cup shape) with a thin metal film formed on the surface thereof. A material having high reflectance such as aluminum is used as the thin metal film.

A reflecting surface of the reflector 32 includes a reflecting curved surface that is formed by causing a parabola to rotate with the symmetry axis of the parabola serving as the rotation axis. This reflector 32 is a parabolic mirror that has the circular opening section 32a in the direction in which light emitted from the phosphor sections 3 and 6 is projected. It should be noted that it is possible to use a member that has an elliptical or free-curved surface shape or a multifaceted member (multi-reflector) other than a parabolic mirror as the reflector 32. Furthermore, a section that is not a curved surface may be included in part of the reflector 32.

Furthermore, a light-projecting member that projects light emitted from the phosphor sections 3 and 6 does not have to be the reflector 32, and may be a projection-type of light-transmitting member in which a lens is used.

In the light-emitting device 30, due to the provision of the phosphor section 6, the difference in the angular distribution of color between the excitation light L1 and L2 and the first fluorescent emitted to outside can be reduced (suppressing the occurrence of a color irregularity). Thus, in the light-emitting device 30, the reflector 32 can be designed without giving consideration to providing an optical member (diffusion sheet or the like) for correcting the angular distribution of color, which can become necessary in the case where a difference occurs in the angular distribution. In other words, in the light-emitting device 30, due to the provision of the phosphor section 6 and suppressing the occurrence of a color irregularity in outgoing light, it becomes possible for the reflector 32 to be easily designed.

Furthermore, outgoing light emitted from the phosphor sections 3 and 6 can be reflected and projected toward the front (predetermined direction) of the opening section 32a. Thus, the utilization efficiency of outgoing light from the light-emitting device 30 can be increased.

Furthermore, the phosphor section 3 is mounted on the support substrate 31, and that support substrate 31 is in contact with the reflector 32. Therefore, heat generated in the phosphor section 3 can be released via the support substrate 31 and the reflector 32. Thus, it is possible to suppress a decline in the efficiency of the conversion to first fluorescence by the phosphor 4 or to second fluorescence by the phosphor 7 and deterioration of the phosphors 4 and 7 caused by the heat. It should be noted that, if this point is not to be taken into consideration, it is not absolutely necessary for the support substrate 31 to have a heat dissipation function, and, in this case, it is sufficient for a substrate having high transparency with respect to excitation light L1 to be used.

Configurations in the case where there is one light source unit 11 have been described in FIG. 7 and FIG. 8; however, it should be noted that there may be a plurality of light source units 11 as mentioned above. A specific configuration thereof will be described using FIG. 9. FIG. 9 is a cross-sectional view depicting the schematic configuration of a light-emitting device 40 according to the present modified example.

The light-emitting device 40 is provided with four light source units 11 and four optical fibers 21. Each light source unit 11 is optically connected to an optical fiber 21 in such a way that the upper surface 12a of the cap 12 of each light source unit 11 and the incoming end section 21a of the respective optical fiber 21 oppose each other. In the present modified example, a configuration is implemented in which there are four each of the light source units 11 and the optical fibers 21; however, it should be noted that there is no restriction thereto, and a similar configuration can be adopted provided there are a plurality thereof. In other words, it is sufficient for a plurality of light source units 11 and a plurality of optical fibers 21 to be provided, and for both groups to be optically connected in such a way that the light source units 11 and the optical fibers 21 are arranged in a one-to-one manner.

The four optical fibers 21 form a bundle fiber 22. In other words, the bundle fiber 22 is a bundle of a plurality of optical fibers 21 that are optically connected to the light source units 11. The bundle fiber 22 has an outgoing end section 22b from which excitation light L1 that has passed through the optical fibers 21 exits. The bundle fiber 22 and the support substrate 31 are optically connected in such a way that this outgoing end section 22b and the light-receiving surface 31a of the support substrate 31 oppose each other.

In this way, even in the case where there are a plurality of light source units 11, it is possible for the phosphor section 3 to be irradiated with excitation light L1 emitted from these light source units 11.

FIG. 9 depicts an example of the case where there are a plurality of light source units 11 in the light-emitting device 30 of embodiment 4; however, it should be noted that the arrangement relationship of the light source units 11, the optical fibers 21, and the bundle fiber 22 may be the same positional relationship as in FIG. 9 also in the case where there are a plurality of light source units 11 in the light-emitting device 20 of embodiment 3.

A light-emitting device (1, 10, 20, 30, 40) according to aspect 1 of the present invention is configuration that is a light-emitting device that emits fluorescence (first fluorescence, second fluorescence) generated by subjecting excitation light (L1, L2) to wavelength conversion and also part of the excitation light to outside, and is provided with: a first light-emitting unit (phosphor section 3) that absorbs the excitation light (L1) and emits first fluorescence; and a second light-emitting unit (phosphor section 6) that absorbs the excitation light (L2) that has passed through the first light-emitting unit without being converted into the first fluorescence by the first light-emitting unit and emits second fluorescence, the peak wavelength of the second fluorescence being approximate to the peak wavelength of the excitation light (L1, L2).

According to the abovementioned configuration, excitation light that has passed through the first light-emitting unit is absorbed in the second light-emitting unit, and therefore the radiant intensity of the excitation light emitted from the second light-emitting unit is able to be reduced. Furthermore, excitation light having strong directivity is converted into second fluorescence by the second light-emitting unit, and therefore the second fluorescence is able to be emitted over a wider range than the excitation light. It is therefore possible for the light distribution characteristics of the excitation light to be made to be light distribution characteristics that have width, as with the light distribution characteristics of the first fluorescence.

Furthermore, the peak wavelength of the second fluorescence is approximate to the peak wavelength of the excitation light. In this way, due to these two peak wavelengths being approximate, a tone that is the same as or close to the tone of the excitation light is able to be realized with the second fluorescence.

Consequently, a light-emitting device according to an aspect of the present invention is able to emit, instead of part of the excitation light, second fluorescence having the same tone as the excitation light. Therefore, as depicted in (b) of FIG. 4, it is possible to suppress the occurrence of a color irregularity in the outgoing light emitted from the light-emitting device.

Furthermore, in a light-emitting device according to an aspect of the present invention, a second light-emitting unit is provided instead of using a scattering agent in a first light-emitting unit. Therefore, different from the case where a scattering agent is used, it is possible to suppress the scattering of excitation light to the excitation light incoming side, and it is possible to suppress a situation in which excitation light that has been scattered to the excitation light incoming side is not able to be used as part of outgoing light. In other words, due to the second light-emitting unit being provided instead of using a scattering agent in the first light-emitting unit, it is possible to prevent a decline in the utilization efficiency of excitation light, and it is also possible to suppress the occurrence of a color irregularity in outgoing light.

In addition, for a light-emitting device according to aspect 2 of the present invention, it is preferable that, in aspect 1,

the first light-emitting unit have a light-outgoing surface (3E) that is a surface on the opposite side to a light-receiving surface (3R) that receives the excitation light,

and the second light-emitting unit be provided on the light-outgoing surface.

According to the abovementioned configuration, excitation light having a high radiant intensity from within the excitation light emitted from the first light-emitting unit is emitted from the light-outgoing surface of the first light-emitting unit. Therefore, due to the second light-emitting unit being mounted on the light-outgoing surface, it is possible for this excitation light having a high radiant intensity to be made to be reliably incident upon the second light-emitting unit.

In addition, for a light-emitting device according to aspect 3 of the present invention, it is preferable that, in aspect 1 or 2,

the particle size of a phosphor (7) that is included in the second light-emitting unit and receives the excitation light and emits the second fluorescence be smaller than the peak wavelength of the excitation light.

According to the abovementioned configuration, in the case where the second light-emitting unit is irradiated with excitation light, it is possible to ensure that Mie scattering does not occur in the second light-emitting unit, and it is therefore possible to suppress excitation light that has passed through the first light-emitting unit scattering to the first light-emitting unit side (in other words, the excitation light incoming side). Thus, it is possible for excitation light that has scattered in the second light-emitting unit to be reliably used as part of the outgoing light, and it is therefore possible to suppress a reduction in the amount of the outgoing light.

In addition, for a light-emitting device according to aspect 4 of the present invention, it is preferable that, in any of aspects 1 to 3,

an excitation light source (laser element 2) that emits the excitation light,

and a light guide member (optical fiber 21) that guides the excitation light emitted from the excitation light source to the first light-emitting unit be provided.

According to the abovementioned configuration, by providing the light guide member, it is possible for the excitation light source and the first light-emitting unit to be arranged away from each other. Thus, it is possible to suppress the first light-emitting unit deteriorating in particular due to heat emitted from the excitation light source.

In addition, for a light-emitting device according to aspect 5 of the present invention, it is preferable that, in any of aspects 1 to 4,

a reflection mirror (reflector 32) that reflects the excitation light and the first fluorescence emitted from the first light-emitting unit, and the excitation light and the second fluorescence emitted from the second light-emitting unit be provided.

According to the abovementioned configuration, it is possible for the excitation light and the first fluorescence emitted from the first light-emitting unit and the excitation light and the second fluorescence emitted from the second light-emitting unit to be projected in a predetermined direction. Thus, it is possible for the utilization efficiency of outgoing light to be increased.

In addition, an illumination device, an illumination fixture for admiring plants, or a vehicle headlamp provided with a light-emitting device according to any of the abovementioned aspects 1 to 5 is also included within the category of the present invention. According to these configurations, it is possible to prevent a decline in the utilization efficiency of excitation light, and it is also possible to suppress the occurrence of a color irregularity in outgoing light even in this illumination device, illumination fixture for admiring plants, or vehicle headlamp.

The present invention is not restricted to the abovementioned embodiments, various alterations are possible within the scope indicated in the claims, and embodiments obtained by appropriately combining the technical means disclosed in each of the different embodiments are also included within the technical scope of the present invention. In addition, novel technical features can be formed by combining the technical means disclosed in each of the embodiments.

It is possible for the present invention to be broadly applied in an illumination fixture for admiring plants and an illumination fixture such as a headlamp for a vehicle or the like, and it is possible for the utilization efficiency of excitation light to be increased.

### REFERENCE SIGNS LIST

1 Light-emitting device
2 Laser element (excitation light source)
3 Phosphor section (first light-emitting unit)
3R Light-receiving surface
3E Light-outgoing surface
6 Phosphor section (second light-emitting unit)
7 Phosphor
10 Light-emitting device
20 Light-emitting device
30 Light-emitting device
40 Light-emitting device
21 Optical fiber (light guide member)
32 Reflector (reflection mirror)
L1 Excitation light
L2 Excitation light

1. A light-emitting device that emits fluorescence generated by subjecting excitation light to wavelength conversion and also part of the excitation light to outside, the light-emitting device comprising:
a first light-emitting unit that absorbs the excitation light and emits first fluorescence; and
a second light-emitting unit that absorbs the excitation light that has passed through the first light-emitting unit without being converted into the first fluorescence by the first light-emitting unit and emits second fluorescence,
a peak wavelength of the second fluorescence being approximate to a peak wavelength of the excitation light.

2. The light-emitting device of claim 1, wherein the first light-emitting unit has a light-outgoing surface that is a surface on an opposite side to a light-receiving surface that receives the excitation light, and
the second light-emitting unit is provided on the light-outgoing surface.

3. The light-emitting device of claim 1, wherein a particle size of a phosphor that is included in the second light-emitting unit and receives the excitation light and emits the second fluorescence is smaller than the peak wavelength of the excitation light.

4. The light-emitting device of claim 1, further comprising:
an excitation light source that emits the excitation light; and
a light guide member that guides the excitation light emitted from the excitation light source to the first light-emitting unit.

5. The light-emitting device of claim 1, further comprising:
a reflection mirror that reflects the excitation light and the first fluorescence emitted from the first light-emitting unit, and the excitation light and the second fluorescence emitted from the second light-emitting unit.
